(19) United States
(12) Patent Application Publication
(10) Pub. No.: US 2004/0196510 A1
(43) Pub. Date: Oct. 7, 2004

(54) Image scanning unit and apparatus using same

(75) Inventor: Dong-Su Nam, Gyunggi-do (KR)

Correspondence Address: STAAS & HALSEY LLP, SUITE 700, 1201 NEW YORK AVENUE, N.W., WASHINGTON, DC, 20005, US

(73) Assignee: SAMSUNG Electronics Co., Ltd., Suwon-city (KR)

(21) Appl. No.: 10/732,255

(22) Filed: Dec. 11, 2003

(30) Foreign Application Priority Data
Apr. 7, 2003 (KR) 2003-21554

(51) Int. Cl. H04N 1/04

(52) U.S. Cl. 358/474

(57) ABSTRACT

An image scanning unit includes an image sensor unit disposed along a document delivery path and having an image scanning surface over which a document travels, the image scanning surface opposing a first surface of the document, a white member which contacts a second side opposing the first side of the document and to urge the document toward the image sensor unit, a surface of the white member opposing the image sensor unit being white in color, and a drive roller disposed along the document delivery path adjacent to the white member, delivering the document between the image sensor unit and the white member, and contacting the second side of the document.

### CROSS-REFERENCE TO RELATED APPLICATIONS

This application claims the benefit of Korean Application No. 2003-21554, filed Apr. 7, 2003, in the Korean Intellectual Property Office, the disclosure of which is incorporated herein by reference.

### BACKGROUND OF THE INVENTION

1. Field of the Invention

The present invention relates to an image scanning unit and, more particularly, to an image scanning unit in which a distance between a drive roller disposed adjacent to a white member and a scanning point of an image sensor unit is reduced to within an optimum range so that performance thereof is increased and the scanning system can be compact and lightweight.

2. Description of the Related Art

An image scanning apparatus such as, for example, a facsimile machine scans an image of a document which is fed along a document delivery path by using an image sensor disposed on or near the document delivery path, and converts the scanned image to an electrical image signal. To celebrate the image sensor, it is known to provide, opposite to the scanning surface of the image sensor, a white roller or a white bar to provide the image sensor with a reference white level or value.

FIG. 1 shows a conventional scanning apparatus using a white roller, and FIG. 2 shows another conventional scanning apparatus using a white bar. The scanning apparatuses of FIGS. 1 and 2 are examples of the conventional scanning apparatus disclosed in Japanese Laid-Open Patent No. 11-41426.

Referring to FIG. 1, the conventional scanning apparatus has an image sensor 14 disposed in a plate groove portion 15 of a document guide 12. A white roller 31 is rotatably disposed above the image sensor 14. The white roller 31 is supported by a supporting member 24, and may serve as a document delivery roller such as a drive roller. That is, the white roller 31 can be used to deliver the document D according to an image scanning speed of the image sensor 14, while the white roller 31 also provides a reference white for the scanned image using a white circumferential surface thereof. The surface of the white roller 31 is substantially uniformly colored white such that as the white roller 31 rotates, the portion of the white roller 31 facing the image sensor 14 is substantially homogeneous and, as a result, a substantially constant white value is provided. The white roller 31 is generally formed of a white rubber material. The white roller 31 may also function to discharge the scanned document, or a separate discharge roller can be provided to discharge the document.

The aforementioned arrangement is not without disadvantages. For example, in the above structure of a conventional image scanning apparatus, the white roller 31, being formed of a rubber material, is easily contaminated. When the image sensor 14 scans an image using a reference white level of the surface of a contaminated white roller 31, deviations in image level sometimes occur. When this happens, problems such as left/right or partial deviations of a printed image occur. Also, to clean a contaminated white roller 31, related components must be disassembled and the contaminated areas wiped with a cleaning agent such as alcohol. As a result, the user experiences inconvenience as a result of the maintenance work on the image scanning apparatus.

FIG. 2 shows another arrangement of a conventional image scanning apparatus, which addresses the shortcomings of the above conventional white roller 31 arrangement. The scanning apparatus has a white bar 41 in place of the white roller 31 (shown in FIG. 1). The white bar 41 is supported by a supporting member 21, and is urged by an elastic member 45 toward the image sensor 14 so that the white bar 41 can face the image sensor 14 at a predetermined distance. On a bottom side of the white bar 41 is disposed a white sheet 44 for providing the image sensor 14 with a reference whiteness level or value. The white bar 41, unlike the white roller 31, is not easily contaminated, since the white bar 41 does not come into contact with the document D and is formed of a hard material such as steel and/or PVC to prevent abrasion and distortion thereof. Therefore, the structure having the white bar 41 can compensate the aforementioned disadvantages of the conventional white roller 31.

However, while the white bar 41 arrangement shown in FIG. 2 does not suffer from many of the disadvantages of the arrangement of FIG. 1, the white roller 31 can control a delivery speed of the document and can deliver the document, while the white bar 41 cannot. Thus, an additional drive roller is required when using the white bar 41. In other words, although not shown in FIG. 2, a drive roller is disposed between the image sensor 14 and an Automatic Documents Feeder (ADF) roller, and an idle roller is disposed to rotate and contact the drive roller. Therefore, the drive roller controls a delivery speed of a paper sheet picked up by the ADF roller.

However, if the drive roller and the idle roller are applied as described above, the scanning apparatus is enlarged and may not keep up with a trend toward miniaturization and portability. Also, manufacturing cost increases.

In addition, as a distance between the drive roller and the scanning point of the image sensor 14 is widened, error range of a skew of a document, a delivery speed, and a left/right deviation increase.

### SUMMARY OF THE INVENTION

The present invention has been devised to solve the above and/or other problems, and an aspect of the present invention is to provide an image scanning unit having an improved structure.

Additional aspects and/or advantages of the invention will be set forth in part in the description which follows and, in part, will be obvious from the description, or may be learned by practice of the invention.

According to one aspect of the present invention, there is provided an image scanning unit including an image sensor unit disposed along a document delivery path which contacts a second side opposing the first side of the document and to urge the document toward the image sensor unit, a surface of the white member opposing the image sensor unit and being white in color, and a drive roller disposed along the document delivery path adjacent to the white member, delivering the document between the image sensor unit and the white member. The drive roller is configured to contact the second side of the document.

The image scanning unit may include an elastic member for urging the white member toward the image sensor unit.

The white member may include an elongated member having a contact surface which contacts the second side of the document and at least one opening which allows a part of the drive roller to pass therethrough and contact the second side of the document.

The elongated member may include a base and the base may include a scanning surface opposing a scanning point of the image sensor unit and extending along a direction perpendicular to the direction of travel of the document, and a guide surface formed upstream of the scanning surface along the delivery path and including at least one opening for the drive roller.

The drive roller may include a plurality of roller bodies separately disposed on a shaft at intervals.

The plurality of roller bodies may be disposed at equal intervals, and each of the plurality of roller bodies may be longer in length than the equal interval between them.

The drive roller may be formed of a rubber material.

The surface of the white member opposing the image sensor unit may be formed of a metallic material coated in white.

According to another aspect of the present invention, an image scanning apparatus includes a pickup roller unit disposed in a main body of the image scanning apparatus, which separates a document to be scanned sheet by sheet into one or more sheets, and feeds each of the one or more sheets to a document delivery path, an image sensor unit disposed along the document delivery path to oppose a first side of each sheet of the one or more sheets traveling over a scanning surface of the image sensor unit, a white member which contacts a second side of each of the one or more sheets and to urge the document toward the image sensor unit, a surface of the white member opposing the image sensor unit being white in color, a drive roller disposed along the document delivery path adjacent to the white member, delivering each of the one or more sheets between the image sensor unit and the white member, and contacting the second side of each of the one or more sheets document, and a discharge unit which discharges each of the one or more sheets past between the image sensor unit and the white member to outside of the main body.

The image scanning apparatus may also include a cover pivotably mounted on an upper portion of the main body, which supports the white member and the drive roller.

The cover may include a downwardly recessed receiving portion which receives the white member and the drive roller.

A shaft portion may protrude from an inner bottom of the receiving portion to rotatably support the drive roller.

Additionally, the image scanning apparatus may also include an elastic member disposed in the receiving portion, to urge the white member toward the image sensor unit.

The discharge unit may include a discharge roller rotatably disposed in the main body, and driven by a driving motor, and an idle roller rotatably disposed and in contact with the discharge roller.

The discharge unit may include a driving force transfer roller rotatably disposed in contact with the idle roller and the drive roller, respectively, and an elastic member which urges the driving force transfer roller into contact with the idle roller and the drive roller so that a driving force of the drive roller is transferred through the driving force transfer roller to the idle roller.

According to yet another aspect of the present invention, there is provided an image scanning unit including: an image sensor having a sensing surface disposed along a document delivery path which senses a side of a document passing over the sensing surface; a white member having a white surface opposing the sensing surface which is sensed by the image sensor and which provides a white reference value, the white member being disposed along the document delivery path on a side opposing the side along which the image sensor is disposed; and a drive roller disposed adjacent to and upstream of the white member along the document delivery path on the same side thereof as the white member. The drive roller successively feeds the document along the document delivery path.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIGS. 1 and 2 are sectional views schematically showing conventional arrangements of image scanning apparatuses respectively;

FIG. 3 is a sectional view showing an image scanning apparatus according to an embodiment of the present invention;

FIG. 4 is a perspective view schematically showing the image scanning apparatus of FIG. 3;

FIG. 5 is a perspective view schematically showing a cover of the image scanning apparatus of FIG. 3;

FIG. 6 is a sectional view showing a drive roller being engaged with the cover of the image scanning apparatus of FIG. 3;

FIG. 7 is a perspective view showing an image sensor unit of the image scanning apparatus of FIG. 3;

FIG. 8 is a perspective view showing a white member of the image scanning apparatus of FIG. 3; and

FIG. 9 is a perspective view showing the drive roller of the image scanning apparatus of FIG. 3.

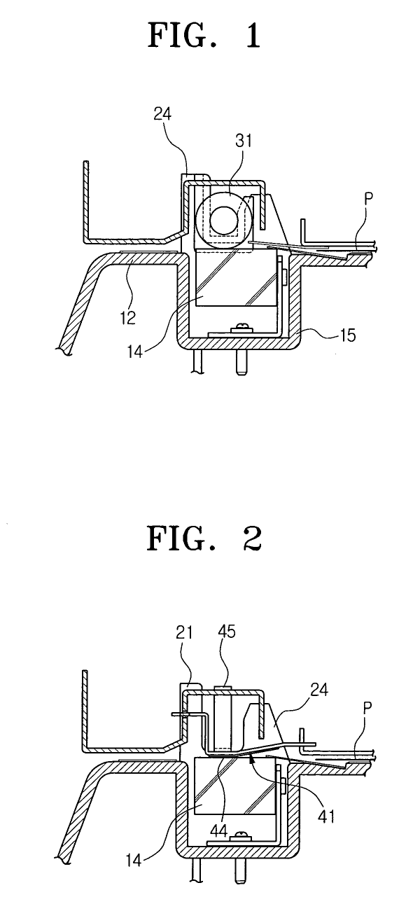

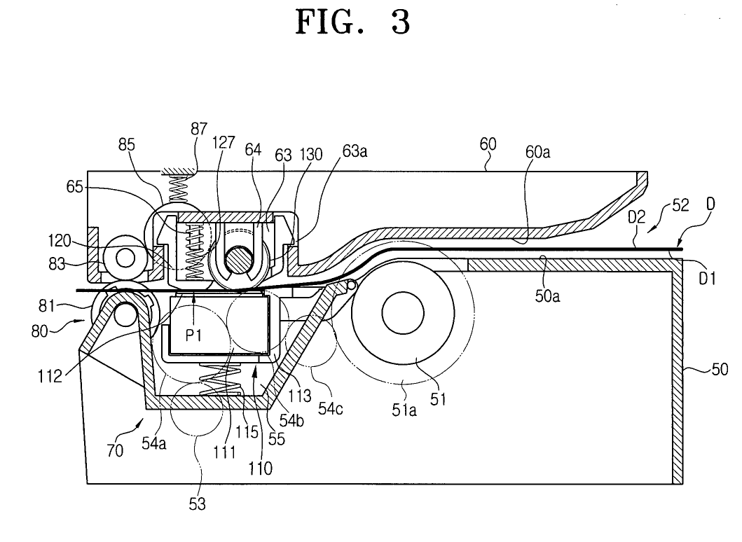

### DETAILED DESCRIPTION OF THE PREFERRED EMBODIMENTS

Reference will now be made in detail to embodiments of the present invention, examples of which are illustrated in the accompanying drawings, wherein like reference numerals refer to the like elements throughout. The embodiments are described below to explain the present invention by referring to the figures.

Referring to FIG. 3, the image scanning apparatus according to an embodiment of the present invention comprises a main body 50, a cover 60 connected to an upper portion of the main body 50 to be opened and closed, a pickup roller 51 disposed in the main body 50 for sorting a document sheet by sheet, an image scanning unit 70 for delivering the document at a predetermined speed and for scanning an image data, and a discharging unit 80 for discharging the scanned document.

A document D is delivered along a delivery path which is formed between a topside 50a of the main body 50 and a bottom side 60a of the cover 60.

The pickup roller 51 separates a document from the document stack of a document feeder 52 sheet by sheet, and delivers each sheet toward the scanning unit 70.

As shown in FIG. 3, the main body 50 has a drive motor 53 for driving the pickup roller 51. The power generated by the drive motor 53 is transferred to a gear 51a of the pickup roller 51 through a plurality of connecting gears 54a, 54b, and 54c.

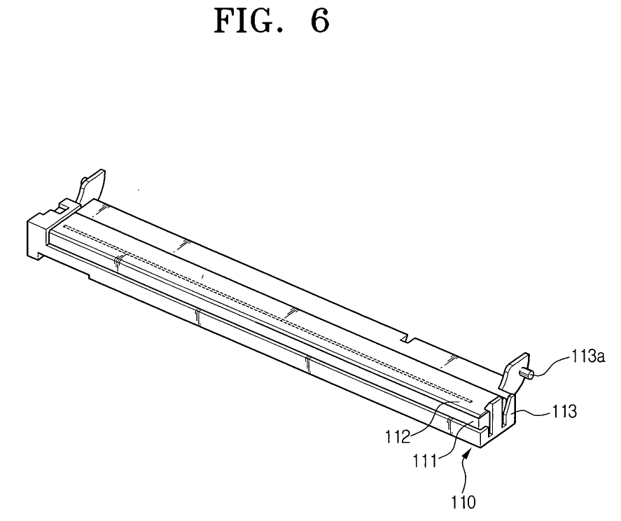

The cover 60 is pivotably connected to the upper portion of the main body 50 to be pivotable between an open position and a closed position (illustrated). Accordingly, a pivot shaft 61 is provided at one end of the cover 60 (shown in FIG. 5). In addition, the cover 60 has an accommodating portion 63 for accommodating a drive roller 130 and a white member 120 which will be described later. Also, on an inner wall of the accommodating portion 63, as shown in FIG. 6, there are provided a shaft holder 64 for rotatably supporting the drive roller 130, and a supporting boss 65 for supporting an elastic member 127 which will be described later. The shaft holder 64 has one end open so that, when a shaft 131 of the drive roller 130 is put through the open end, the shaft holder 64 is elastically deformed outwardly to receive the shaft 131, as illustrated by FIG. 6. Next, the shaft holder 64 is elastically restored so as to restrain the shaft 131 from releasing. A lubricant such as, for example, grease, may be provided between the shaft holder 64 and the shaft 131 to reduce a friction therebetween.

The image scanning unit 70 comprises an image sensor unit 110 disposed in the main body 50, a white member 120 corresponding to the image sensor unit 110, and a drive roller 130. The image sensor unit 110 is known for scanning an image of a delivered document.

The image sensor unit 110 includes an image sensor 111, a transparent glass plate 112 disposed on the upper surface of the image sensor 111 to contact the first surface D1 of the document D fed along the document delivery path, and a sensor holder 113 for supporting the image sensor 111 thereon.

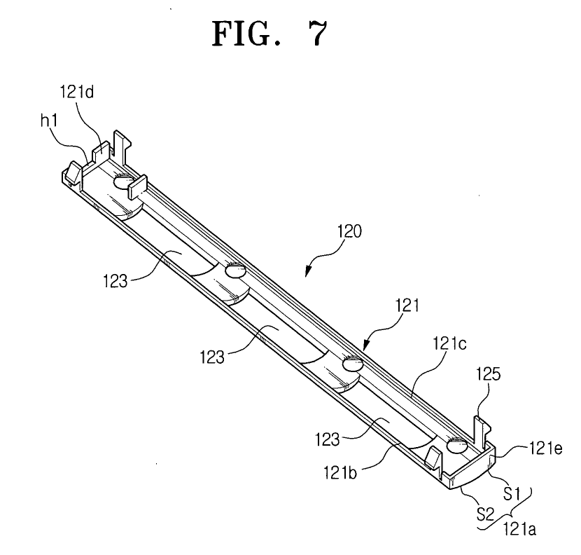

Referring now to FIG. 7, the image sensor 111 is seated, and thus supported on the sensor holder 113. The image sensor 111, together with the transparent plate 112, is exposed to the topside 50a of the main body 50. An contact image sensor (CIS), by way of a non-limiting example, may be used as the image sensor 111. The sensor holder 113 moves upward and downward about one end of a hinge shaft 113a. The sensor holder 113 is accommodated in a sensor mounting unit 55 of the main body 50. Also, an elastic member 115 is disposed in a lower portion of the sensor holder 113 to elastically urge the image sensor 110 upwardly, i.e., toward the white member 120 and the drive roller 130.

The white member 120 is disposed to oppose the image sensor unit 110, and also oppose the second surface D2 which is opposite to the first surface D1 of the document D. More specifically, the white member 120 is disposed at a position corresponding to a scanning point P1 of the image sensor unit 110. The white member 120 corresponds in length and width to the accommodating portion 63 of the cover 60, and is disposed in the accommodating portion 63. The image sensor unit 110 scans image data of a document D, and the white member 120 provides a reference white value. The white member 120 may be partially coated in white at an area opposite to the second surface D2 of the document D, or the white member 120 may be formed of white material.

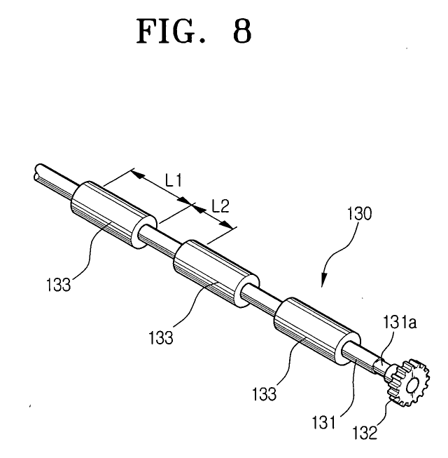

Referring now to FIG. 8, the white member 120 is provided with an elongated member 121. The elongated member 121 has a base wall 121a. First and second sidewalls 121b, 121c are formed at both ends of the base wall 121a opposing each other. Additionally, the white member 120 has first and second sidewalls 121d, 121e connecting the base wall 121a with the first and the second sidewalls 121b, 121c of the elongated member 121.

The base wall 121a has at least one opening 123 defined therein, so that the drive roller 130 is passed through the opening 123 of the base wall 121a to contact the second surface D2 of the document D. According to the present embodiment, the base wall 121a has three openings 123 which are defined at uniform intervals.

The base wall 121a has a scanning surface S1 extending along a direction perpendicular to the direction of travel of the document D to oppose the scanning point P1 of the image sensor unit 110, and a guide surface S2 upstream of the scanning surface along the document delivery path. The guide surface S2 is connected with the first sidewall 121b of the elongated member 121. A part of the guide surface S2 is slanted. The slanted surface of the guide surface S2 guides the delivery of the document which ingresses between the white member 120 and the image sensor unit 110. The openings 123 are formed in the slanted surface of the guide surface S2 so as to expose the drive roller 130 through the slanted surface.

Each of the first sidewall 121b and the second sidewall 121c of the elongated member 121 is provided with a plurality of resilient hooks 125 at an upper portion thereof. The resilient hooks 125 are respectively locked into corresponding locking recesses 63a formed in the accommodating portion 63 (shown in FIG. 3). Additionally, the first and the second sidewalls 121d, 121e of the white member 120 may be provided with the extra resilient hooks. At one end of the sidewalls 121d, 121e of the white member 120, a shaft recess h1 is formed so that the drive roller 130 (shown in FIG. 3) passes thereon. A recess h1 is formed in the second sidewall 121d of the white member 120. The base wall 121a and the first and the second sidewalls 121b, 121c of the elongated member 121, and the first and the second sidewalls 121d, 121e, of the white member 120, define a space to accommodate the drive roller 130 which is rotatable therein. The openings 123 are formed in the white member 120 so that the drive roller 130 is accommodated therein and exposed outwardly. Accordingly, a distance from the scanning surface S1 to the drive roller 130, (i.e. a distance from the scanning point P1 to the drive roller 130) is optimized. A typical dimension for the image sensor includes a width of the sensor being about 20 mm. Thus, the distance between the scanning point P1 and the drive roller 130 can be optimized to be within 20 mm.

Turning back to FIG. 3, the white member 120 is urged toward the image sensor unit 110 by the elastic member 127 so as to maintain a constant gap with the image sensor unit 110 for normal scanning. The elastic member 127 is shown to be a coil spring which is fixed to and supported at a supporting boss 65 on the inner wall of the accommodating portion 63. However, it is to be understood that other arrangements which urge the white member 120 toward the image sensor unit 110 may be used.

The drive roller 130 is formed adjacent to the white member 120 on the document delivery path. More specifically, the drive roller 130 is at an upstream ahead of the scanning surface S1 (shown in FIG. 8) and is disposed to be rotated in contact with the second surface D2 of the document D. The drive roller 130 aligns the tip ends of the documents D picked up by the pickup roller 51, and delivers the document D to between the image sensor unit 110 and the white member 120 at a predetermined scanning speed.

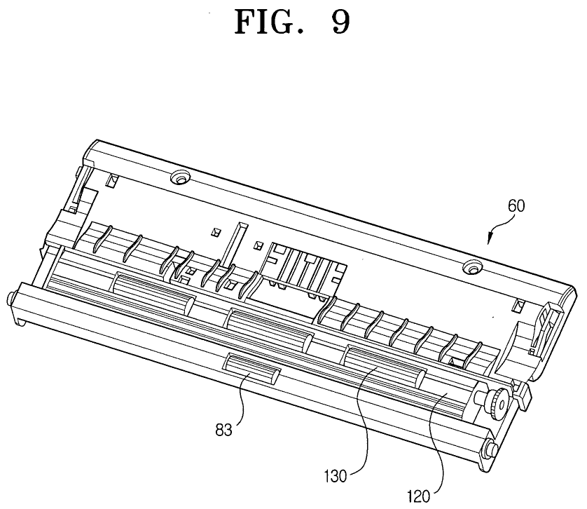

Referring now to FIG. 9, the drive roller 130 comprises the shaft 131, and a roller body 133 disposed along an outer circumference of the shaft 131. One end of the shaft 131 is connected with a drive gear 132. As explained above, the shaft 131 is rotatably supported by the shaft holder 64 in the accommodating portion 63 of the cover 60. A support portion 131a is formed around an end of the shaft 131, having a circumference less than that of the shaft 131 so that a location supported by the supporting member 64 is fixed. Accordingly, the support portion 131a stably rotates while being supported on the shaft holder 64, and the support portion 131a inhibits the drive roller 130 from moving in a lengthwise direction of the shaft 131. The roller body 133 is formed of an elastic material such as a rubber, and is fixed to the shaft 131 and rotates along with the shaft 131. A plurality of roller bodies 133 are formed at equal intervals. In other words, three roller bodies 133 are formed at the equal interval L2, each having a length L1 longer than the interval L2. The roller bodies 133 are respectively exposed outward through the corresponding openings 123 and rotated in contact with the transparent plate 111 of the image sensor unit 110. The drive gear 132 is connected to the connecting gear 54b (shown in FIG. 3) and is rotated with the power transferred from the drive motor 53. The connecting gear 54b may be a clutch gear having a clutch function. Accordingly, the pickup roller 51 and the drive gear 130 (shown in FIG. 3) can be rotated altogether or selectively.

As described above, since the drive roller 130 is disposed adjacent to the white member 120, a distance from the drive roller 130 to the scanning point P1 (hereinafter, refer to as “main gap”) can be shortened to an optimum distance. As a result, problems occurring in the main gap, such as a skew of the document, or data location errors with respect to the document D such as speed error or left/right deviations can be reduced.

Also, by minimizing the main gap, damage to the document due to the pressure of the white member 120 is minimized. Since the drive roller 130 has a function of the conventional white roller which delivers a document D, the conventional idle roller can be omitted. As a result, a manufacturing cost is reduced and a product gets compact-sized due to the reduced number of parts.

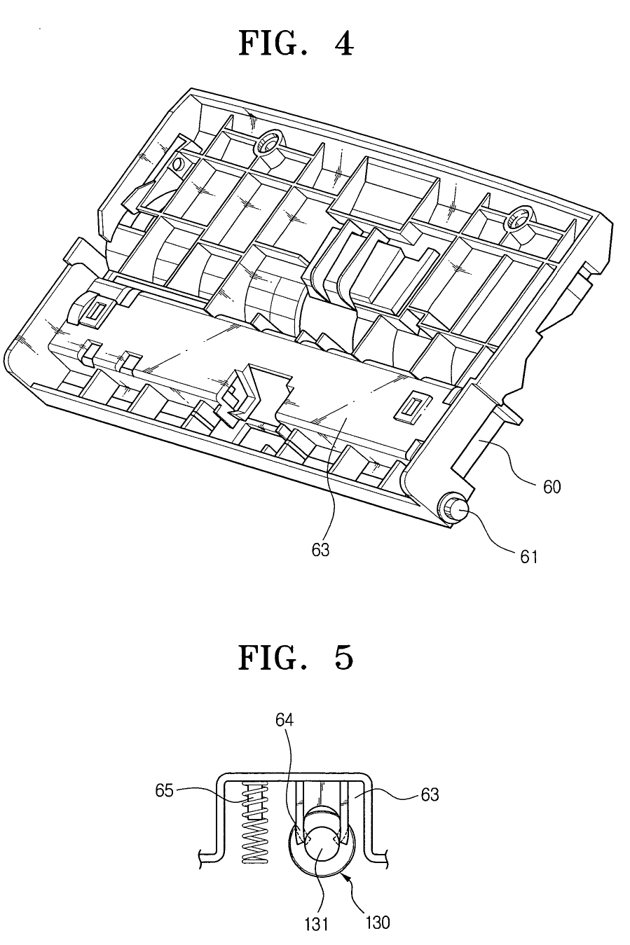

Referring now to FIG. 4, the discharging unit 80 discharges the document which is passed through the image sensor unit 110 and the white member 120. The discharging unit 80 comprises a discharge roller 81 disposed on the main body 50, and an idle roller 83 rotating in mesh with the discharge roller 81. The discharge roller 83 is rotated by a power transferred from the drive motor 53 via the connecting gear 54a. The idle roller 83 is disposed in the cover 60, and is driven by a power transferred from the drive roller 130 via a power transfer roller 85. The idle roller 83 and the power transfer roller 85 are formed of a rubber material so that the power transfer roller 85 transfers the power of the drive roller 130 to the idle roller 83 by virtue of a frictional force. To this end, an outer circumference of the power transfer roller 85 is longer than a distance between the drive roller 130 and the idle roller 83, as shown in FIG. 3, and the power transfer roller 85 is urged by an elastic member 87 toward the drive roller 130 and the idle roller 83. This configuration is applied since the drive roller 130 is disposed adjacent to the scanning point P1, and therefore, an additional gear train is not required.

The operation of a portion of the image scanning apparatus having the above structure is similar to that of the conventional image scanning apparatus, so a detailed description thereon is omitted. However, it takes less time for a document delivered by the drive roller 130 to reach the scanning point P1, and a distance for the same is reduced. Therefore, the probability of having errors is decreased.

In the image scanning unit having the above structure according to an embodiment of the present invention, the drive roller 130 is disposed adjacent to the white member 120 and opposite to the image sensor unit 110. Therefore, the white member 120 can provide a reliable white value, and the drive roller 130 functions to deliver the document D in place of the white roller 120. As a result, a distance from the drive roller 130 to the scanning point P1 of the image sensor unit 110 is greatly reduced to within an optimum distance range, i.e., 20 mm, so that the scanning system can be compact and lightweight.

Another advantage is that the probability of a high-quality scanned image is increased, because errors which were mainly occurring in the main gap, such as a skew of the document D, or errors of the data location on the document D including delivery speed error and left/right deviations, are reduced by optimizing the main gap between the drive roller 130 and the scanning point P1.

Yet another advantage is that a high-quality scan image can be obtained through a precise image compensation based on a reliable reference whiteness value which is provided by the white member 120.

Yet another advantage is that damage to the document D is prevented by minimizing the document pressing time and pressing area of the white member 120 through the minimized main gap between the drive roller 130 and the scanning point P1.

Although a few embodiments of the present invention have been shown and described, the present invention is not limited to the disclosed embodiments. Rather, it would be appreciated by those skilled in the art that changes and modifications may be made in this embodiment without departing from the principles and spirit of the invention, the scope of which is defined by the claims and their equivalents.

What is claimed is:

1. An image scanning unit comprising:
an image sensor unit disposed along a document delivery path and having an image scanning surface over which a document travels, the image scanning surface opposing a first surface of the document;
a white member which contacts a second side opposing the first side of the document and to urge the document toward the image sensor unit, a surface of the white member opposing the image sensor unit being white in color; and
a drive roller disposed along the document delivery path adjacent to the white member, delivering the document between the image sensor unit and the white member, and contacting the second side of the document.

2. The image scanning unit of claim 1, further comprising an elastic member which urges the white member toward the image sensor unit.

3. The image scanning unit of claim 1, wherein the white member comprises an elongated member having a contact surface which contacts the second side of the document and at least one opening which allows a part of the drive roller to pass therethrough and contact the second side of the document.

4. The image scanning unit of claim 3, wherein the elongated member comprises a base which includes:
a scanning surface opposing a scanning point of the image sensor unit and extending along a direction perpendicular to the document delivery path; and
a guide surface upstream of the scanning surface along the document delivery path and including the at least one opening.

5. The image scanning unit of claim 1, wherein the drive roller further comprises a plurality of roller bodies separately disposed on shaft at intervals.

6. The image scanning unit of claim 5, wherein the plurality of roller bodies are disposed at equal intervals, each of the plurality of roller bodies being longer than the intervals between them.

7. The image scanning unit of claim 1, wherein the drive roller is formed of a rubber material.

8. The image scanning unit of claim 1, wherein the surface of the white member opposing the image sensor unit comprises a metallic material coated in white.

9. The image scanning unit of claim 1, wherein the image scanning unit is a contact image sensor.

10. The image scanning unit of claim 1, wherein the white member is disposed at a scanning point of the image sensor unit.

11. The image scanning unit of claim 10, wherein a distance between the drive roller and the scanning point is optimized so that at least one of document skew and data location errors are minimized.

12. The image scanning unit of claim 11, wherein the distance is less than or equal to 20 mm.

13. The image scanning unit of claim 1, wherein the white member provides a reference white value to the image scanning unit.

14. The image scanning unit of claim 13, wherein the reference white value is used to calibrate the image scanning unit.

15. The image scanning unit of claim 2, wherein the elastic member is a coil spring.

16. The image scanning unit of claim 2, wherein the elastic member urges the white member toward the image scanning unit so as to maintain a constant space between the white member and the image scanning unit during a scanning operation.

17. The image scanning unit of claim 1, wherein the drive roller is disposed upstream along the document delivery path.

18. The image scanning unit of claim 1, wherein the drive roller rotates at a constant speed.

19. The image scanning unit of claim 1, wherein the drive roller, upon rotation, delivers each sheet to a scanning position between the image scanning unit and the white member.

20. The image scanning unit of claim 1, wherein the drive roller is rotatably supported by a shaft holder which has an elastically-deformable open end which is elastically deformed when a shaft of the drive roller is inserted therein.

21. An image scanning apparatus, comprising:
a pickup roller unit disposed in a main body of the image scanning apparatus, which separates a document to be scanned sheet by sheet into one or more sheets, and feeds the one or more sheets to a document delivery path;
an image sensor unit disposed along the document delivery path to oppose a first side of each of the one or more sheets, each of the one or more sheets traveling over a scanning surface of the image sensor unit;
a white member which contacts a second side of each of the one or more sheets and to urge each of the one or more sheets toward the image sensor unit, a surface of the white member opposing the image sensor unit being white in color;
a drive roller disposed along the document delivery path adjacent to the white member, delivering each of the one or more sheets between the image sensor unit and the white member, and contacting the second side of each of the one or more sheets; and
a discharge unit which discharges each of the one or more sheets past between the image sensor unit and the white member to outside of the main body.

22. The image scanning apparatus of claim 21, further comprising a cover pivotably mounted on an upper portion of the main body which supports the white member and the drive roller.

23. The image scanning apparatus of claim 22, wherein the cover includes a downwardly recessed receiving portion which receives the white member and the drive roller.

24. The image scanning apparatus of claim 23, wherein a shaft portion protrudes from an inner bottom of the receiving portion to rotatably support the drive roller.

25. The image scanning apparatus of claim 23, further comprising an elastic member disposed in the receiving portion to urge the white member toward the image sensor unit.

26. The image scanning apparatus of claim 21, wherein the discharge unit comprises:
a discharge roller rotatably disposed in the main body, and driven by a driving motor; and
an idle roller rotatably disposed and in contact with the discharge roller, the idle roller being driven by the drive roller.

27. The image scanning apparatus of claim 26, wherein said discharge unit comprises:
a driving force transfer roller rotatably disposed in contact with the idle roller and the drive roller, respectively; and
an elastic member which urges the driving force transfer roller into contact with the idle roller and the drive roller so that a driving force of the drive roller is transferred through the driving force transfer roller to the idle roller.

28. An image scanning unit comprising:
an image sensor having a sensing surface disposed along a document delivery path which senses a side of a document passing over the sensing surface;
a white member having a white surface opposing the sensing surface which is sensable by the image sensor and which provides a white reference value, the white member being disposed along the document delivery path on a side opposing the side along which the image sensor is disposed; and
a drive roller disposed adjacent to and upstream of the white member along the document delivery path on the same side thereof as the white member, the drive roller feeding the document along the document delivery path.
